(19) United States
(12) Patent Application Publication
(10) Pub. No.: US 2013/0227221 A1
(43) Pub. Date: Aug. 29, 2013

(54) CACHE ACCESS ANALYZER

(71) Applicant: Lei Yu, Austin, TX (US)

(72) Inventor: Lei Yu, Austin, TX (US)

(73) Assignee: Advanced Micro Devices, Inc., Sunnyvale, CA (US)

(21) Appl. No.: 13/408,015

(22) Filed: Feb. 29, 2012

(51) Int. Cl. G06F 12/08

(52) U.S. Cl. 711/135; 711/118; 711/E12.022

(57) ABSTRACT

A performance monitor records performance information for tagged instructions being executed at an instruction pipeline. For instructions resulting in a load or store operation, a cache access analyzer can decompose the address associated with the operation to determine which cache line, if any, of a cache is accessed by the operation, and which portion of the cache line is requested by the operation. The cache access analyzer records the cache line portion in a data record, and, in response to a change in instruction being executed, stores the data record for subsequent analysis.

### BACKGROUND

1. Field of the Disclosure

The present disclosure relates to software tools for efficiency analysis of a central processing unit architecture.

2. Description of the Related Art

A processor, such as a central processing unit (CPU) can execute sets of instructions in order to carry out tasks indicated by the sets of instructions. The processor typically includes an instruction pipeline to fetch instructions for execution, and to execute operations, such as load and store operations, based on the fetched instructions. The efficiency with which the sets of instructions employ the resources of the processor depends on a variety of factors, including the organization of each instruction set and the pattern of memory accesses by the instruction set. However, with the wide variety of processor resources, and the disparate impact of instruction organization on those resources, it can be difficult to determine how to organize a program efficiently. Accordingly, a processor can employ a performance monitor that records information about how sets of instructions use processor resources.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a central processing unit (CPU) in accordance with one embodiment of the present disclosure.

FIG. 2 is a block diagram of the cache of FIG. 1 processor in accordance with one embodiment of the present disclosure.

FIG. 3 is a block diagram of a cache line of the cache of FIG. 2 processor in accordance with one embodiment of the present disclosure.

FIG. 4 is a block diagram of the cache utilization analyzer of FIG. 1 processor in accordance with one embodiment of the present disclosure.

FIG. 5 is a diagram of the cache access data of FIG. 4 in accordance with one embodiment of the present disclosure.

FIG. 6 is a diagram of the cache access data of FIG. 4 in accordance with another embodiment of the present disclosure.

FIG. 7 is a flow diagram of a method of determining which portions of a cache line have been accessed in accordance with one embodiment of the present disclosure.

FIG. 8 is a block diagram of a computer device in accordance with one embodiment of the present disclosure.

The use of the same reference symbols in different drawings indicates similar or identical items.

### DETAILED DESCRIPTION

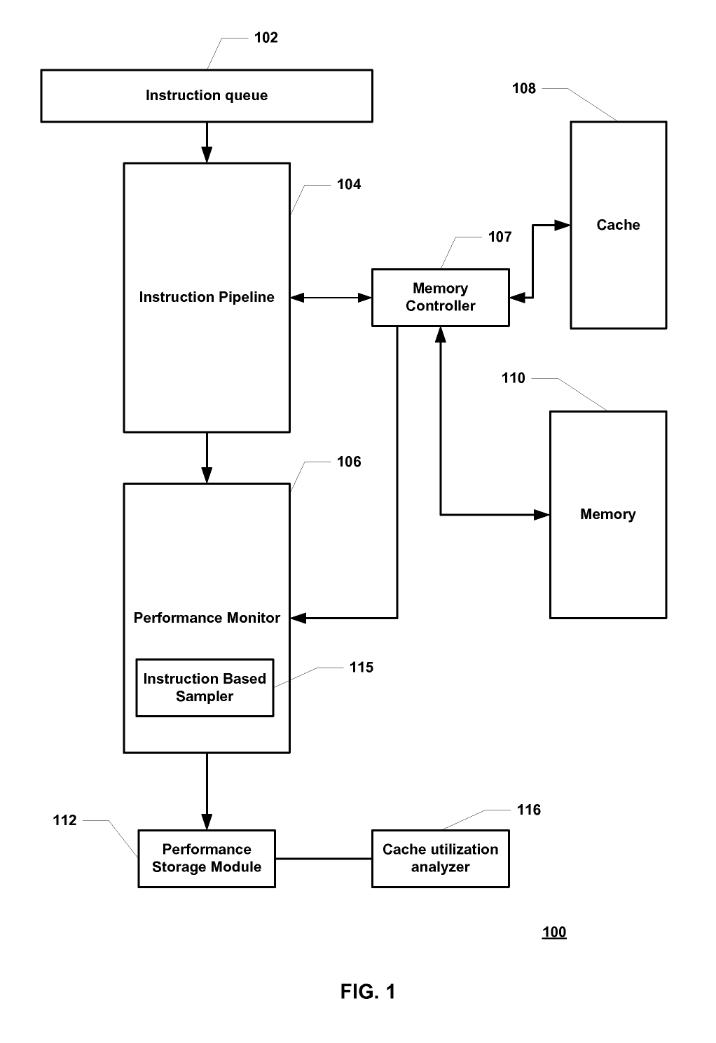

FIGS. 1-8 illustrate techniques for recording which portions of a cache line have been accessed by one or more instructions. Accordingly, in an embodiment a performance monitor records performance information for tagged instructions being executed at an instruction pipeline. The performance monitor can record the information using instruction based sampling, whereby the analyzer records the operations resulting from designated instructions, such as instructions sampled periodically. Thus, for instructions resulting in a load or store operation, the performance monitor will record the memory addresses accessed by each operation. A cache access analyzer can use the recorded memory address information to determine which cache lines of a cache are accessed by each executed instruction, and which portion of the accessed cache lines were requested by the each instruction's operations.

As used herein, a portion of a cache line is selectively accessed if the portion is accessed without the access resulting in or corresponding to an access of all of the portions of the cache line. By determining, based on recorded performance information, which portions of a cache line were selectively accessed, the cache access analyzer can provide a programmer with useful information about how the program uses the cache. For example, the programmer could determine that a set of instructions accesses one cache line frequently, but only accesses one portion, such as a single byte, of that cache line. Accordingly, the programmer can reorganize the program so that its memory access pattern is more efficient. For example, the programmer can tune the program so that it more frequently accesses different portions of a particular cache line.

FIG. 1 illustrates a block diagram of a portion of a central processing unit (CPU) 100 in accordance with one embodiment of the present disclosure. The CPU 100 includes an instruction queue 102, an instruction pipeline 104, a performance monitor 106, a memory controller 107, a cache 108, a memory 110, and a performance storage module 112. The CPU 100 is generally configured to execute programs composed of sets of instructions, thereby performing tasks associated with the programs. Accordingly, the CPU 100 can be incorporated into a variety of electronic devices, such as computer devices, handheld electronic devices such as cell phones, automotive devices, and the like. Although the embodiment of FIG. 1 is described in the context of a CPU, similar cache-tracking mechanisms may be employed in other types of processors, such as a digital signal processor (DSP) or graphical processing unit (GPU), without departing from the scope of the present disclosure.

The instruction queue 102 stores a set of instructions scheduled for execution. In an embodiment, in response to a power-on reset indication, the CPU 100 automatically loads an initial set of instructions to the instruction queue 102. As the processor 102 executes instructions, the instructions are fetched from the instruction queue 102, and additional instructions are loaded to the queue for subsequent execution. Each instruction to be executed is associated with its own identifier, referred to as an instruction address, which indicates a location at the memory where the instruction is stored. In an embodiment, an instruction prefetcher (not shown) determines the instruction addresses for instructions to be executed, and loads the instructions indicated by the instructions addresses to the instruction queue 102.

The instruction pipeline 104 is a set of modules generally configured to execute instructions. Accordingly, the instruction pipeline 104 can include a number of stages, whereby each stage performs a different aspect of instruction execution. Thus, the instruction pipeline 104 can include a fetch stage to fetch instructions for execution, a decode stage to decode each fetched instruction into a set of operations, a set of execution units to execute the operations, and a retire stage to retire instructions upon, for example, completion of their operations.

An example of an operation executed by the instruction pipeline 104 is a memory access operation, which can be a read operation or a write operation. A read operation requests the CPU 100 to retrieve data (the read data) stored at a location indicated by an address operand (the read address) and provide the retrieved data to the instruction pipeline 104. A write operation requests the CPU 100 to store a data operand (the write data) at a location indicated by an address operand (the write address).

The memory controller 107 is a module configured to receive control signaling indicative of read operations and write operations, and their associated operands, and in response to satisfy those operations. Thus, in response to a read operation, the memory controller 107 retrieves the read data from a storage location indicated by the read address and, in response to a write operation, stores the write data at a storage location indicated by the write address.

In at least one embodiment, the read addresses and write addresses associated with read and write operations are logical addresses, whereas the actual memory location of the read or write data is indicated by a physical address. The memory controller 107 maintains a mapping between logical addresses and physical addresses. Accordingly, the memory controller 107 is configured to translate received logical addresses to physical addresses in order to satisfy read and write operations.

The cache 108 is a module configured to store and retrieve information in response to control signaling indicative of write and read operations, respectively. As described further herein, the cache 108 includes a set of segments, each segment referred to as a cache line, whereby each segment is associated with a designated memory address. In an embodiment, a cache line is the smallest unit of data that is retrieved and stored at the cache 108 in response to determining that the cache does not store information associated with a received write or read address. For example, in one embodiment, each cache line of cache 108 is 64 bytes long. Accordingly, if information associated with a received read or write address is not stored at the cache 108, the CPU 100 will retrieve 64 bytes of information, including the read data or write data associated with the received read or write address, and store the retrieved data at a cache line of the cache 108. In an embodiment, each cache line includes portions that can be individually accessed in response to a read or write operation. Thus, in one embodiment information stored at a cache line can be accessed by a read or write operation at the granularity of a byte.

The memory 110 is one or more memory modules that store and retrieve data based on read and write operations. The memory 110 can be a random access memory (RAM), a non-volatile memory such as a hard disk or flash memory, or a combination thereof.

The performance monitor 106 is one or more modules configured to determine and record performance information as instructions are being executed at the CPU 100. The performance monitor 106 includes an instruction based sampler 115 that samples performance information for a subset of the instructions executed at the instruction pipeline 104. Examples of types of performance information that can be sampled include the instruction addresses of instructions being executed, the read and write addresses of read and write operations being executed, types of memory access operations being executed, cache access information, information indicating which execution units are employed by executing instructions, and the like. In an embodiment, the subset of instructions for which performance information is sampled is programmable using a register value or other programmable information. Thus, the subset of instructions can include all instructions executed at the instruction pipeline 104, or a smaller subset of instructions based on time intervals, address intervals, or other information. Further, in an embodiment the particular information recorded for each instruction is programmable.

The performance storage module 112 is a memory device, such as a disk drive, flash memory, or other memory device, configured to store the sampled performance information for subsequent retrieval and analysis. In an embodiment, the instruction based sampler 115 provides the sampled performance information to a software driver (not shown), such as a kernel mode driver that stores the sampled data at the performance storage module 112.

FIG. 1 also illustrates a cache utilization analyzer 116 that analyzes the performance information stored at the performance storage module 112. In an embodiment, the cache utilization analyzer 116 is a software program executing at the CPU 100. In another embodiment, the cache utilization analyzer 116 is executed at a device, such as a server or other computer device external to the CPU 100.

The cache utilization analyzer 116 analyzes the performance information stored at the performance storage module 112 to determine, for each read operation and each write operation, which portions of each cache line were accessed by the operation. Thus, the cache utilization analyzer 106 can determine and record not only whether a particular cache line is accessed, but also which portion of the cache line is accessed. Further, as described further herein, the cache utilization analyzer 116 can make the determination based on the physical address associated with each read and write operation. This can reduce performance analysis overhead.

In operation, the instruction pipeline 104 executes instructions fetched from the instruction queue 102. An executing instruction can generate one or more read or write operations. In response to a read operation, the instruction pipeline 104 provides control signaling to the memory controller 107 indicating the read address and a read operation.

In response, the memory controller 107 translates the read address to a physical address and determines if the read data indicated by the physical address is stored at the cache 108. If so, the memory controller 108 retrieves the read data from the cache 108 and provides it to the instruction pipeline 104. If the read data is not stored at the cache 108, the memory controller 107 retrieves information including the read data from the memory 110, the size of the retrieved information corresponding to a cache line. The memory controller 107 stores the retrieved information at a cache line of the cache 108, and provides the read data to the instruction pipeline 104.

In response to a write operation, the instruction pipeline 104 provides control signaling to the memory controller 107 indicating the write address, the write data, and a write operation. In response, the memory controller 107 translates the write address to a physical address and determines if data associated with the physical address is stored at the cache 108. If so, the memory controller 108 writes the write data to the cache 108. If data associated with the physical address is not stored at the cache 108, the memory controller 107 retrieves information associated with the physical address from the memory 110, the size of the retrieved information corresponding to a cache line. The memory controller 107 stores the retrieved information at a cache line of the cache 108, and writes the read data to the location indicated by the physical address. In an embodiment, as the memory controller 107 retrieves information from the memory 110 for storage at the cache 108, it can evict other information stored at the cache in order to make room for the retrieved information.

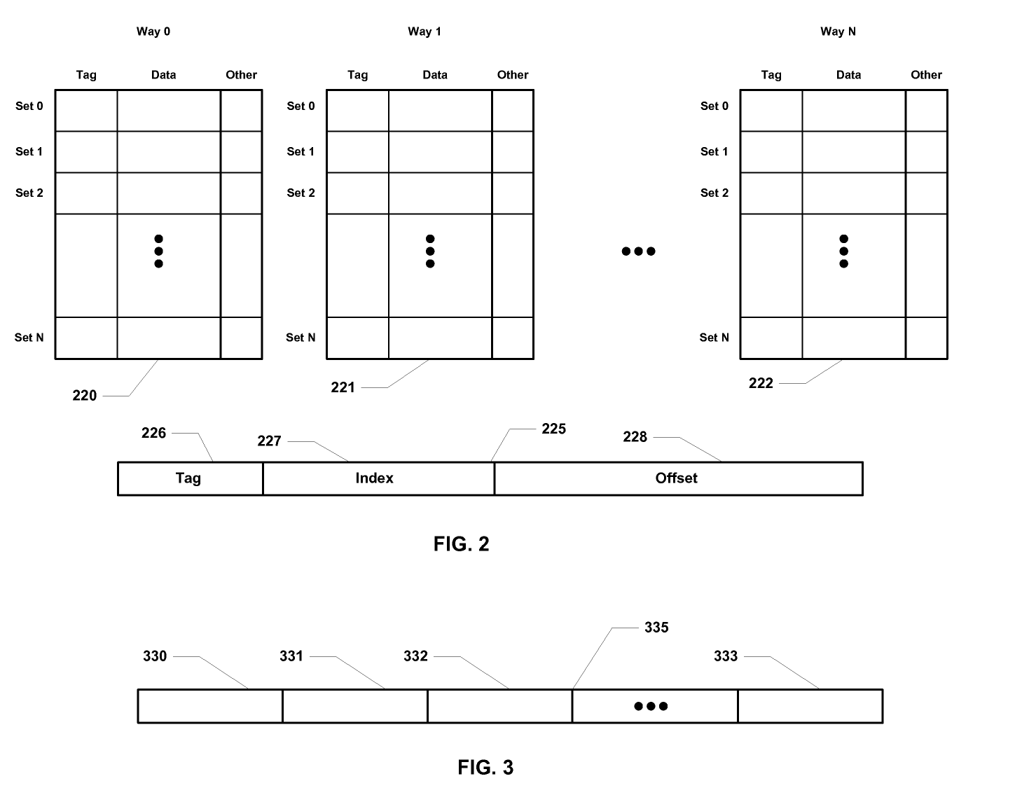

In addition, in response to each read or write operation, the instruction pipeline indicates the operation to the performance monitor 106. Further, the memory controller 107 provides the physical address associated with the operation to the performance monitor 106. The instruction based sampler 115 samples the physical address and stores it at the performance storage module 112. Based on the recorded physical address, the cache utilization analyzer 116 determines which portion of a cache line of the cache 108, if any, was accessed by the operation. This can be better understood with reference to FIGS. 2-6.

FIG. 2 illustrates a block diagram of the cache 108 in accordance with one embodiment of the present disclosure. The cache 108 includes N ways (where N is an integer) including way 220, way 221, and way 223. Each way includes N sets, whereby each set is associated with a tag field (indicated by the column labeled “Tag”), a cache line to store data (indicated by the column labeled “Data”), and an Other field. The Other field can store control information associated with the cache line, such as coherency information, protection and security information, and the like.

The tag field of a set stores the tag associated with the cache line of the set. This can be better understood with reference to physical address 225 illustrated at FIG. 2. The physical address 225 includes a tag portion 226, an index portion 227, and an offset portion 228. The memory controller 107 identifies the cache location associated with a physical address based on these portions. In particular, the index portion 227 indicates which set of the ways 220-222 is associated with the physical address. The tag portion 226 indicates the tag that is stored at the indicated set of a selected way. The offset portion 228 indicates which portion of a cache line is associated with the physical address. To illustrate, FIG. 3 depicts a cache line 335 including portions 330-333. Each of the portions 330-333 is uniquely identified by a different offset. In an embodiment, the cache line 335 is 64 bytes long, and each of the portions 330-333 is one byte.

Returning to FIG. 2, in response to a read or write operation, the memory controller 107 decomposes the physical address associated with the operation to its tag, index, and offset portions. Based on the index portion, the memory controller 107 determines a set of the cache 108. The memory controller 107 retrieves the tags stored at each way of the indicated set, and compares the tags to the tag portion of the physical address. If there is a match, the memory controller 107 determines the way that stores the matching tag and satisfies the read or write operation at the indicated way based on the offset portion of the physical address. For example, in the case of a read operation, the memory controller 107 retrieves the data from the cache line portion indicated by the offset portion of the physical address. In the case of a write operation, the memory controller 107 writes the write data to the cache line portion indicated by the offset portion of the physical address.

If none of the tags stored at the set match the tag portion of the physical address, the memory controller 107 retrieves, based on the physical address, information from the memory 108. The retrieved information is the size of a cache line, and includes the data stored at the memory location indicated by the physical address. The memory controller 107 stores the retrieved information at a selected one of the ways of the set indicated by the index portion of the physical address. In an embodiment, the memory controller 107 selects a way by first selecting a way that does not store valid data at the cache line of the set. If all the ways store valid information, the memory controller 107 selects one of the ways for eviction and stores the retrieved information at the cache line of the selected way. In addition, the memory controller 107 stores the tag field of the set and way.

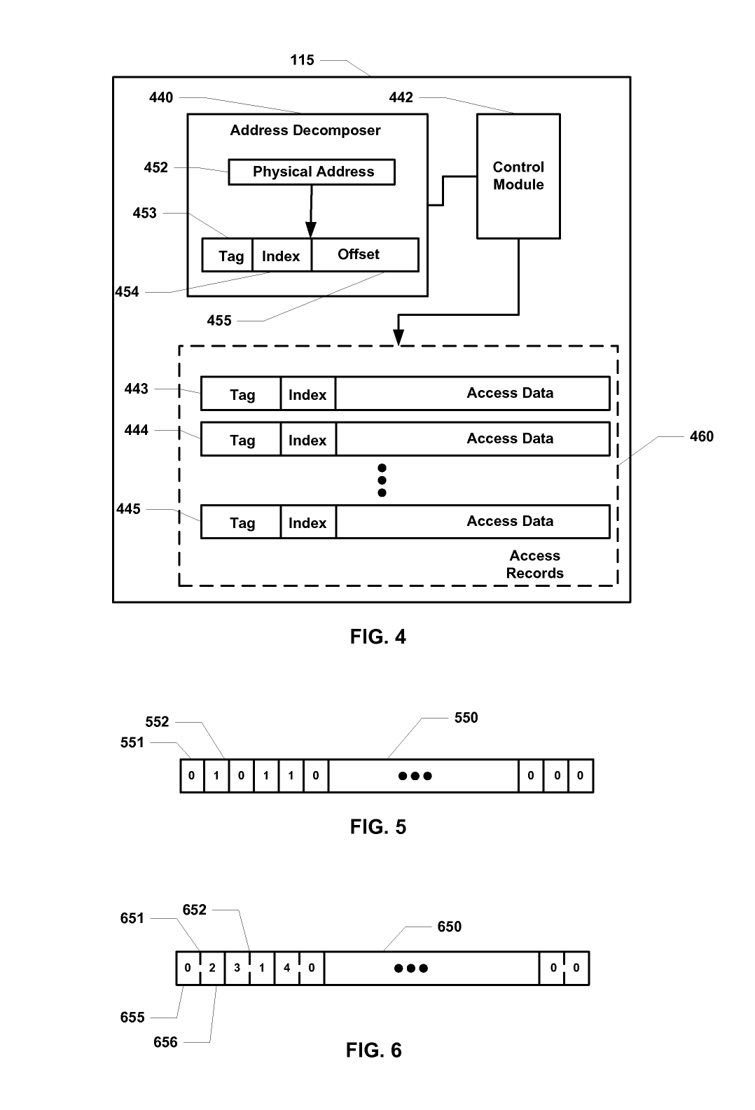

Because the physical address indicates both which cache line, and which portion of a cache line, has been accessed, the cache utilization analyzer 116 can employ the physical address to record cache utilization information. This can be better understood with reference to FIG. 4, which illustrates the cache utilization analyzer 116 in accordance with one embodiment of the present disclosure. In the illustrated embodiment, the cache utilization analyzer 116 includes an address decomposer 440, a control module 442, and a set 460 of access records including access records 443-445. In an embodiment, each of the access records 443-445 is associated with a different cache line of the cache 108. Each of the access records 443-445 includes a tag field and an index field, collectively storing physical address information associated with the access record. addition, each of the access records 443-445 includes an access data field, indicating which portions of a cache line have been accessed.

In operation, the cache utilization analyzer 116 analyzes stored performance information to determine physical addresses associated with read and write operations. The stored performance information includes a set of physical addresses that were accessed by load and store operations associated with one or more instructions. The address decomposer 440 decomposes each physical address into its tag portion, index portion, and offset portion. For example, in the illustrated embodiment the address decomposer 440 decomposes a physical address 452 into a tag portion 453, an index portion 454, and an offset portion 455. The control module 442 compares the tag portion 453 and the index portion 454 to the corresponding information stored at the tag and index fields of the access records corresponding to the cache lines indicated by the received physical address. In the event of a match, the control module 442 determines, based on the offset portion, which portion of the cache line was accessed, and stores an indication of the access at the corresponding access data field.

If no match is found for both the tag and index portions, this indicates that the cache line corresponding to the tag and index portions was evicted. In response, the control module 442 transfers the access data for the cache line to the a storage location, such as a data file, clears the access data at the access record for the cache line, and stores the tag, index, and offset at the corresponding field of the access record. Further, after clearing the access data, the control module 442 determines, based on the offset field of the received physical address, which portion of the cache line was accessed, and stores an indication of the access at the corresponding access data field.

FIG. 5 illustrates access data of FIG. 4 in accordance with one embodiment of the present disclosure. In the illustrated embodiment, access data 550 includes a set of fields, whereby each field corresponds to a different portion of a cache line. For example, if a cache line is 64 bytes long, and can be accessed at the granularity of a byte, the access data 550 can include 64 fields, with each field corresponding to a different byte of the cache line. A “0” value stored at a field, such as field 551, indicates that the corresponding portion of the cache line has not been accessed, while a “1” value stored at field, such as field 552, indicates that the corresponding portion of the cache line has been accessed.

FIG. 6 illustrates access data of FIG. 4 in accordance with another embodiment of the present disclosure. In the illustrated embodiment, access data 650 includes a set of fields, whereby each field corresponds to a different portion of a cache line. Further, each field includes a read subfield, indicating a number of read operations to the corresponding cache line portion, and a write subfield, indicating a number of write operations to the corresponding cache line portion. Thus, field 651 includes a read subfield 655, indicating zero read operations were performed at the associated cache line portion, and a write subfield 656, indicating two write operations were performed at the corresponding cache line portion. Field 652 indicates that 3 read operations and 1 write operation were performed at the corresponding cache line portion.

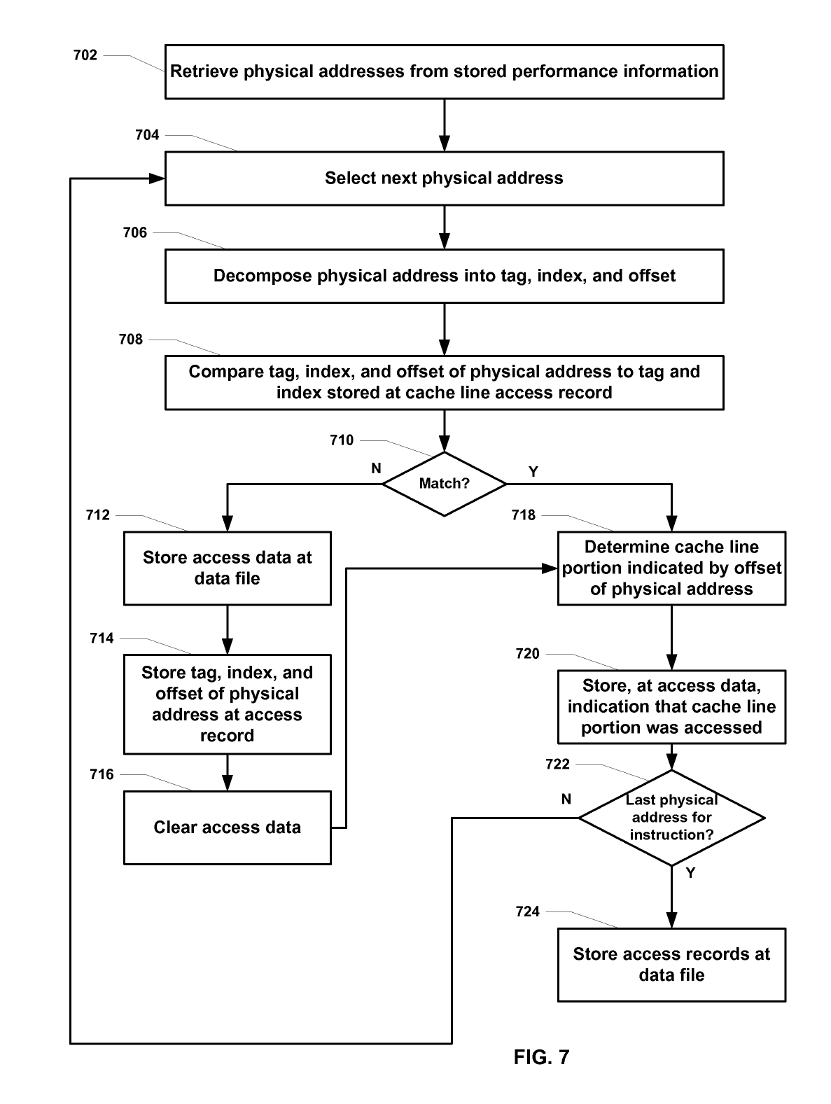

FIG. 7 illustrates a flow chart of a method of determining which portions of a cache line were accessed by a set of operations in accordance with one embodiment of the present disclosure. At block 702, the cache utilization analyzer 115 retrieves physical addresses associated with load and store operations from stored performance information recorded by performance monitor 106. The cache utilization analyzer 115 can place the retrieved physical addresses in an order matching the order with which the corresponding load and store operations were executed.

At block 704 the cache utilization analyzer 115 selects the next physical address to be analyzed from the order of physical addresses. At block 706 the cache utilization analyzer 115 decomposes the retrieved physical address into its tag, index, and offset information. At block 708, the cache utilization analyzer 115 determines, based on the tag and index information of the physical address, which of the access records 443-445 corresponds to the cache line associated with the physical address. The cache utilization analyzer 115 compares the tag and index information to the tag and index fields of the access record and determines if the information matches at block 710.

If there is a not a match, this indicates the cache line corresponding to the access record was evicted, and the method flow proceeds to block 712. At block 712, the cache utilization analyzer 115 stores the access data of the access record at a data file. The data file can be associated with the set of instructions, that caused the load and store operations being analyzed.

At block 714 the cache utilization analyzer 115 replaces the tag and index fields of the access record with the tag and index information of the decomposed physical address. At block 716 the cache utilization analyzer 115 clears the access data of the access record. At block 718 the cache utilization analyzer 115 determines, based on the offset information of the decomposed physical address, which cache line portion was accessed. At block 720 the cache utilization analyzer 115 stores, at the access data of the access record, an indication of which cache line portion was accessed. At block 722 the cache utilization analyzer 115 determines if all of the retrieved physical addresses have been analyzed. If not, the method flow returns to block 704. If all of the address have been analyzed, the method flow moves to block 724 and the cache utilization analyzer 115 stores the access data at the access records to the data file.

Returning to block 710, if the cache utilization analyzer 115 determines that the tag and index information of a decomposed physical address matches the tag and index fields of an access record, the method flow proceeds to block 718 to record, at the access data, which portion of the corresponding cache line was accessed based on the physical address. Accordingly, in the illustrated embodiment, the portions of each cache line that is access is accumulated over time until the cache line is either evicted or all of the set of physical addresses have been analyzed. The resulting data file stores a profile of the cache line access pattern for the set of instructions, whereby the pattern indicates which portions of a cache line were accessed by the set, and which operations led to evictions of each cache line. The data file can be employed by a programmer to determine how to tune a set of instructions to improve the efficiency of the set's cache access pattern.

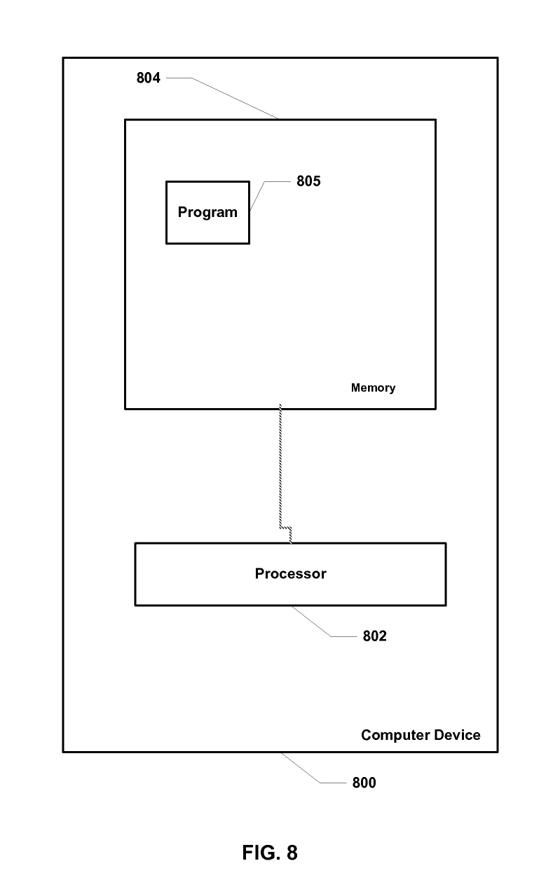

FIG. 8 illustrates a block diagram of a particular embodiment of a computer device 800. The computer device 800 includes a processor 802 and a memory 804. The memory 804 is accessible to the processor 802.

The processor 802 can be a microprocessor, controller, or other processor capable of executing a set of instructions. The memory 804 is a computer readable storage medium such as random access memory (RAM), non-volatile memory such as flash memory or a hard drive, and the like. The memory 804 stores a program 805 including a set of instructions to manipulate the processor 802 to perform one or more of the methods disclosed herein. For example, the program 805 can manipulate the processor 802 to storing, based on a physical address associated with a memory access, an indication of which portion of a cache line is selectively accessed by the memory access.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A computer-implemented method comprising:
recording, based on a physical address associated with a memory access at a processor, an indication of which portion of a cache line is selectively accessed by the memory access.

2. The method of claim 1, wherein recording comprises recording a number of times that the portion of the cache line has been accessed by a plurality of memory accesses including the memory access.

3. The method of claim 2, wherein recording the number of times that the portion has been accessed comprises determining a number of times that the portion has been accessed between loading selected data into the cache line and evicting the selected data from the cache line.

4. The method of claim 3, further comprising determining the selected data has been evicted from the cache line based on a comparison of a portion of the physical address associated with the memory access to a portion of a physical address associated with a previous memory access.

5. The method of claim 2, wherein recording the indication comprises recording a number of times that the portion has been accessed by read accesses.

6. The method of claim 2, herein recording the indication comprises recording that the portion has been accessed by write accesses.

7. The method of claim 1, further comprising storing, based on a physical address associated with another memory access, an indication that a different portion of the cache line is selectively accessed.

8. The method of claim 1, further comprising modifying a computer program based on the indication.

9. The method of claim 1, wherein recording comprises storing a record of which portions of the cache line have been accessed by a plurality of memory accesses including the memory access, and further comprising providing the record to an external analyzer for analysis.

10. The method of claim 9, further comprising modifying a portion of a computer program based on the analysis.

11. A computer readable medium tangibly embodying instructions to manipulate a processor, the instructions comprising instructions to store, based on a physical address associated with a memory access, an indication that a portion of a cache line is selectively accessed by the first memory access.

12. The computer readable medium of claim 11, wherein the instructions to store the indication comprise instructions to store a number of times that the portion of the cache line has been accessed by a plurality of memory accesses.

13. The computer readable medium of claim 12, wherein the instructions to store the number of times that the portion has been accessed comprise instructions to determine a number of times that the portion has been accessed between loading selected data into the cache line and evicting the selected data from the cache line.

14. The computer readable medium of claim 13, further comprising instructions to determine the data has been evicted from the cache line based on a comparison of a portion of a current physical address associated with the memory access to a portion of a physical address associated with a previous memory access.

15. The computer readable medium of claim 12, wherein the instructions to store the indication comprise instructions to store a number of times that the portion has been accessed by read accesses.

16. The computer readable medium of claim 12, wherein the instructions to store the indication comprise instructions to store a number of times that the portion has been accessed by write accesses.

17. The computer readable medium of claim 13, further comprising instructions to store, based on a physical address associated with another memory access, an indication that a different portion of the cache line is selectively accessed.

18. A processor device configured to:
record, based on a physical address associated with a memory access, an indication of which portion of a cache line is selectively accessed by the memory access.

19. The processor device of claim 18, wherein the processor device is configured to record a number of times that the portion of the cache line has been accessed by a plurality of memory accesses including the memory access.

20. The processor device of claim 19, wherein the processor device is configured to record that the portion has been accessed by write accesses.
